(19) United States
(12) Patent Application Publication
(10) Pub. No.: US 2026/0034559 A1
(43) Pub. Date: Feb. 5, 2026

(54) APPARATUS AND METHOD FOR MANUFACTURING ELECTRODE PLATE OF SECONDARY BATTERY INCLUDING SUBSTRATE SHRINKAGE PREVENTION UNIT

(71) Applicant: Samsung SDI Co., Ltd., Yongin-si (KR)

(72) Inventor: Haeseong LIM, Yongin-si (KR)

(21) Appl. No.: 19/185,379

(22) Filed: Apr. 22, 2025

(30) Foreign Application Priority Data
Aug. 5, 2024 (KR) 10-2024-0104260

(51) Int. Cl. B05C 9/14; B05C 13/02; B05C 21/00; H01M 4/04

(52) U.S. Cl. CPC B05C 9/14; B05C 13/02; B05C 21/00; H01M 4/0404

(57) ABSTRACT

An apparatus for manufacturing an electrode plate of a secondary battery includes a transfer roller configured to transfer an electrode plate substrate of the secondary battery, a coater configured to coat the electrode plate substrate transferred by the transfer roller with an electrode material, a dryer configured to dry the electrode plate substrate coated by the coater, and a shrinkage preventer configured to prevent a widthwise shrinkage force of the electrode plate substrate.

### CROSS-REFERENCE TO RELATED APPLICATION

The present application claims priority to and the benefit of Korean Patent Application No. 10-2024-0104260, filed on Aug. 5, 2024, in the Korean Intellectual Property Office, the entire disclosure of which is incorporated herein by reference.

### BACKGROUND

### 1. Field

The present disclosure relates to an apparatus and method for manufacturing an electrode plate of a secondary battery, and more particularly, to manufacturing of an electrode plate including coating and drying.

### 2. Discussion of Related Art

Secondary batteries are batteries that can be (re)charged and discharged, unlike primary batteries that cannot be recharged. In general, the secondary battery may include an electrode assembly having positive and negative electrode plates and a separator. The positive and negative electrode plates may be manufactured through a coating process of coating an active material mixture on one or both sides of an electrode substrate, a roll pressing process of making the electrode plate thin and flat by compressing and stretching the electrode plate coated with the mixture by the coating process, a slitting process of cutting the electrode plate coated in multiple rows in a longitudinal direction to separate the electrode plate into individual electrode plates, and a notching process of cutting each separated electrode plate in a width direction, removing unnecessary portions, and forming tabs.

The above information disclosed in this Background section is for enhancement of understanding of the background of the present disclosure, and therefore, it may contain information that does not constitute related (or prior) art.

### SUMMARY

According to an aspect of the present disclosure, there is provided an apparatus for manufacturing an electrode plate of a secondary battery, including a transfer roller configured to transfer an electrode plate substrate of the secondary battery, a coating unit configured to coat the substrate transferred by the transfer roller with an electrode material, a drying unit configured to dry the substrate coated with the electrode material by the coating unit, and a shrinkage prevention unit configured to prevent a widthwise shrinkage force of the substrate.

According to another aspect of the present disclosure, there is provided a method of manufacturing an electrode plate of a secondary battery, including coating an electrode plate substrate of the secondary battery with an electrode material, drying the substrate coated with the electrode material by the coating, and preventing shrinkage by preventing a widthwise shrinkage force of the substrate.

### BRIEF DESCRIPTION OF THE DRAWINGS

Features will become apparent to those of skill in the art by describing in detail exemplary embodiments with reference to the attached drawings, in which:

FIG. 1 schematically shows an electrode assembly of a secondary battery;

FIG. 2 schematically shows a pouch-type secondary battery;

FIG. 3 is a cross-sectional view of a cylindrical secondary battery;

FIG. 4 is a view of an internal configuration of a prismatic secondary battery;

FIG. 5 schematically shows a process of manufacturing an electrode plate of the electrode assembly illustrated in FIGS. 1;

FIG. 6 illustrates a single row coated electrode plate coated by a coating unit of FIG. 5;

FIG. 7 illustrates a multi-row coated electrode plate coated by the coating unit of FIG. 5;

FIG. 8 is a side view of a coating device according to some embodiments of the present disclosure;

FIGS. 9 and 10 show the operating principle of a shrinkage prevention unit according to some embodiments;

FIG. 11 is a configuration view of the shrinkage prevention unit according to some embodiments;

FIG. 12 shows a specific configuration of a clamp;

FIG. 13 is a configuration view of the clamp according to some embodiments;

FIG. 14 is a configuration view of the clamp according to some other embodiments;

FIG. 15 is an exemplary view of a secondary battery module in which secondary batteries manufactured according to the present disclosure are arranged;

FIG. 16 is an exemplary view of a secondary battery pack including the secondary battery module of FIG. 15; and

FIG. 17 is a conceptual view of a vehicle including the secondary battery pack of FIG. 16.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms.

The embodiments described in this specification and the configurations shown in the drawings are only some of one or more embodiments of the present disclosure and do not represent all of the aspects of the present disclosure. Accordingly, it should be understood that there may be various equivalents and modifications that can replace or modify one or more embodiments described herein at the time of filing this application.

It will be understood that if an element or layer is referred to as being “on,” “connected to,” “coupled to,” or “linked to” another element or layer, or “between” two elements or layers, it may be directly on, connected, coupled or linked to the other element or layer (or directly between two elements or layers) or one or more intervening elements or layers may also be present. When an element or layer is referred to as being “directly on,” “directly connected to,” or “directly coupled to” another element or layer (or “directly between”), there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements throughout. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

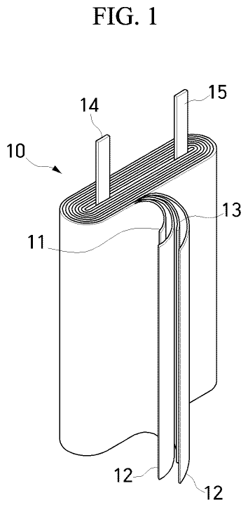

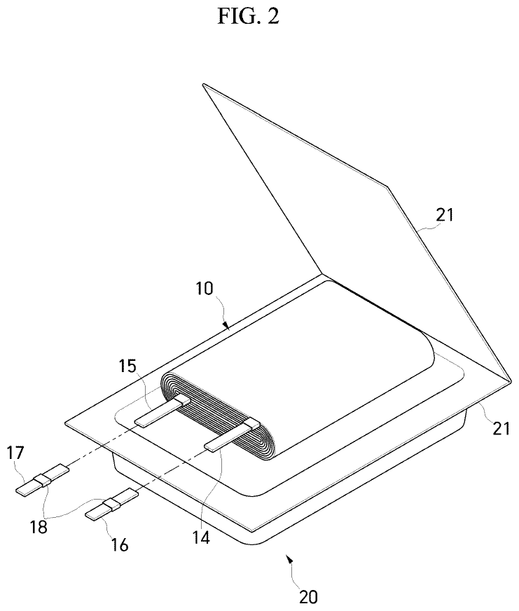

FIG. 1 schematically shows an electrode assembly of a secondary battery, and FIG. 2 schematically shows a pouch-type secondary battery with the electrode assembly of FIG. 1.

Referring to FIG. 1, an electrode assembly 10 may be formed by winding or stacking a stack of a first electrode plate 11, a separator 12, and a second electrode plate 13, which are formed as thin plates or films. When the electrode assembly 10 is a wound stack, a winding axis may be parallel to the longitudinal direction of the case. In other embodiments, the electrode assembly 10 may be a stack type rather than a winding type. In addition, the electrode assembly 10 may be a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case. The first electrode plate 11 of the electrode assembly may act as a negative electrode, and the second electrode plate 13 may act as a positive electrode, e.g., the reverse is also possible.

The first electrode plate 11 may be formed by applying a first electrode active material, such as graphite or carbon, to a first electrode current collector formed of a metal foil, such as copper, a copper alloy, nickel, or a nickel alloy. The first electrode tab 14 may be connected to an external first terminal. In some embodiments, when the first electrode plate 11 is manufactured, the first electrode tab 14 may be formed by being cut in advance to protrude to one side of the electrode assembly 10, or the first electrode tab 14 may protrude to one side of the electrode assembly 10 more than (e.g., farther than or beyond) the separator 12 without being separately cut.

The second electrode plate 13 may be formed by applying a second electrode active material, such as a transition metal oxide, on a second electrode current collector formed of a metal foil, such as aluminum or an aluminum alloy. The second electrode plate 13 may include a second electrode tab 15 (e.g., a second uncoated portion) that is a region to which the second electrode active material is not applied. The second electrode tab 15 may be connected to an external second terminal. In some embodiments, the second electrode tab 15 may be formed by being cut in advance to protrude to the other side (e.g., the opposite side) of the electrode assembly 10 when the second electrode plate 13 is manufactured, or the second electrode plate 13 may protrude to the other side of the electrode assembly more than (e.g., farther than or beyond) the separator 12 without being separately cut.

In some embodiments, the first electrode tab 14 may be located on the left side of the electrode assembly 10, and the second electrode tab 15 may be located on the right side of the electrode assembly 10. In other embodiments, the first electrode tab 14 and the second electrode tab 15 may be located on one side of the electrode assembly 10 in the same direction. Here, for convenience of description, the left and right sides are defined according to the electrode assembly 10 as oriented in FIG. 1, and the positions thereof may change when the secondary battery is rotated left and right or up and down.

The separator 12 prevents a short-circuit between the first electrode plate 11 and the second electrode plate 13 while allowing movement of lithium ions therebetween. The separator 12 may be made of, e.g., a polyethylene film, a polypropylene film, a polyethylene-polypropylene film, or the like.

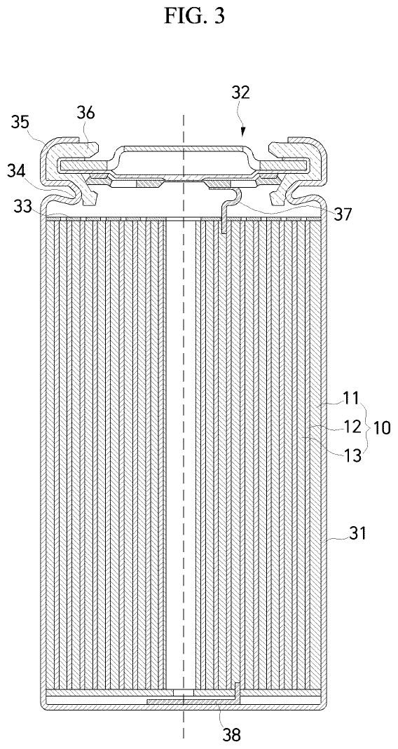

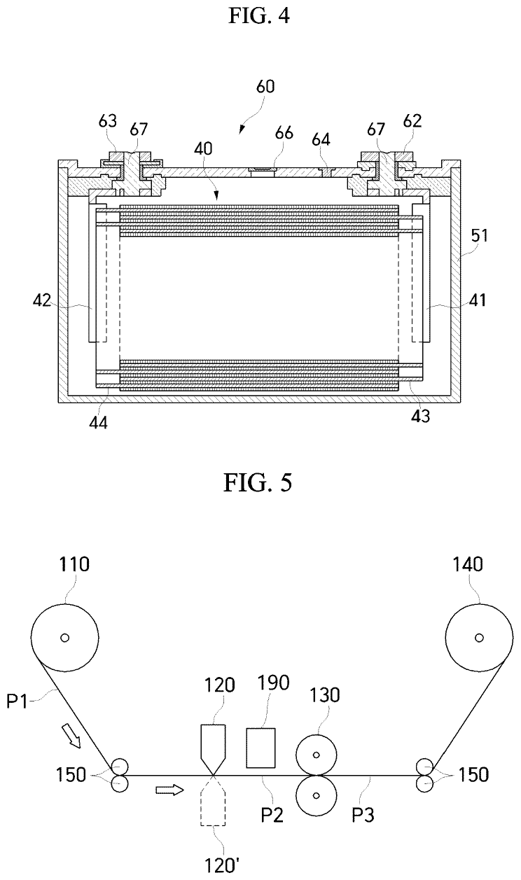

In some embodiments, the electrode assembly 10 may be accommodated in the case along with an electrolyte. In the case of a pouch-type secondary battery, the electrode assembly 10 may be accommodated in a pouch made of flexible material in the form illustrated in FIG. 2. In the case of a cylindrical or prismatic secondary battery, the electrode assembly may be accommodated in a cylindrical or prismatic metal casing in the form illustrated in FIGS. 3 and 4.

Referring to FIG. 2, the pouch-type secondary battery may include the electrode assembly 10 and a pouch 20 that accommodates the electrode assembly 10. The first electrode tab 14 and the second electrode tab 15 of the electrode assembly 10 may be electrically connected to respective external first and second terminal leads 16 and 17 by welding. Each of the first terminal lead 16 and the second terminal lead 17 may be attached with a tab film 18 for insulation from the pouch 20.

The pouch 20 may be sealed by having sealing parts 21 at the edges thereof come into contact with each other with accommodating the electrode assembly 10 therein, in which case the sealing may be achieved with the tab film 18 interposed between the sealing parts 21. The sealing parts 21 of the pouch 20 may each be made of a thermal fusion material that generally has weak adhesion to metal. Thus, it may be fused to the pouch 20 by interposing the thin tab film 18 between the sealing parts 21.

FIG. 3 is a cross-sectional view of a cylindrical secondary battery. Referring to FIG. 3, the cylindrical secondary battery may include the electrode assembly 10, a case 31 accommodating the electrode assembly 10 and an electrolyte therein, a cap assembly 32 coupled to an opening of the case 31 to seal the case 31, and an insulating plate 33 positioned between the electrode assembly 10 and the cap assembly 32 inside the case 31.

The case 31 may accommodate the electrode assembly 10 and the electrolyte, and, together with the cap assembly 32, may form the external appearance of the secondary battery. The case 31 may have a substantially cylindrical body portion and a bottom portion connected to one side (e.g., to one end) of the body portion. A beading part 34 (e.g., a bead) deformed inwardly may be formed in the body portion, and a crimping part 35 (e.g., a crimp) bent inwardly may be formed at an open end of the body portion.

The beading part 34 can reduce or prevent movement of the electrode assembly 10 inside the case 31 and can facilitate seating of the gasket and the cap assembly 32. The crimping part 35 may firmly fix the cap assembly 32 by pressing the edge of the case 31 against a gasket 36. The case 31 may be formed of, e.g., iron plated with nickel.

The cap assembly 32 may be fixed to the inside of the crimping part 35 by the gasket 36 to seal the case 31. A first lead tab 37 drawn out from the electrode assembly 10 may be connected to the cap assembly 32, and a second lead tab 38 drawn out from the electrode assembly 10 may be electrically connected to the bottom of the case 31.

FIG. 4 is a view of an internal configuration of a prismatic secondary battery. Referring to FIG. 4, a prismatic secondary battery may include an electrode assembly 40, a first current collector 41, a first terminal 62, a second current collector 42, a second terminal 63, a case 51, and a cap assembly 60.

An electrode assembly 40 may be formed by winding or stacking a stack of a first electrode plate, a separator, and a second electrode plate, which are formed as thin plates or films. When the electrode assembly 40 is a wound stack, a winding axis may be parallel to the longitudinal direction of the case 51. In other embodiments, the electrode assembly 40 may be a stack type rather than a winding type. In addition, the electrode assembly 40 may be a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case. The first electrode plate of the electrode assembly may act as a negative electrode, and the second electrode plate may act as a positive electrode, e.g., the reverse is also possible.

In the electrode assembly 40, the first current collector 41 and the second current collector 42 may be welded and connected to the first electrode tab 43 extending from the first electrode plate and the second electrode tab 44 extending from the second electrode plate, respectively. As mentioned above, in some embodiments in which the first electrode tab 43 and the second electrode tab 44 are located at the top of the electrode assembly 40, the first and second current collectors are located at the top of the electrode assembly 40.

As illustrated in FIG. 4, the first current collector 41 and the second current collector 42 may be connected to the first terminal 62 and the second terminal 63 through connection members 67, respectively. For example, the connection members 67 may each have an outer peripheral surface that is threaded, and may be fastened to the first terminal 62 and the second terminal 63 by screwing. In another example, the connection members 67 may also be coupled to the first terminal 62 and the second terminal 63 by riveting or welding.

FIG. 5 is a schematic view of a process and apparatus for manufacturing an electrode plate of the electrode assembly 10 used in the secondary battery of the above-described pouch type, cylindrical type, prismatic type, or the like.

Referring to FIG. 5, a supply roll 110 may be a roll on which a substrate P1 for an electrode plate is wound. For example, when an apparatus for manufacturing electrode plates according to the present disclosure is used to manufacture a positive electrode plate, the substrate P1 may be a metal foil containing aluminum (Al). In another example, when the apparatus for manufacturing electrode plates according to the present disclosure is used to manufacture a negative electrode plate, the substrate P1 may be a metal foil containing copper (Cu) or nickel (Ni).

For example, a transfer roller 150 may be an idle roller that guides the substrate P1 into an unwound from the supply roll 110. In another example, the transfer roller 150 may be a drive roller that applies a pulling force to allow the substrate P1 to be unwound from the supply roll 110. FIG. 5 illustrates a total of four transfer rollers 150 as an example only, and the number and positions of transfer rollers may be changed as needed.

A coating unit 120 (e.g., a coater) may form a coating layer by coating the substrate P1 with an electrode material slurry that is previously prepared to form a coated substrate P2. A drying unit 190 (e.g., a dryer) may be positioned adjacent to the coating unit 120 to dry the coating layer.

Here, the coated layer may include a coating mixture including an active material. For example, the coting mixture may include a lithium transition metal oxide, a binder, and a volatile solvent when the apparatus for manufacturing an electrode plate according to the present disclosure is used to manufacture a positive electrode plate. Even when manufacturing a negative electrode plate, a mixture of the active material, the binder, and the solvent may be prepared. In addition, it is also possible to simultaneously coat both surfaces of the substrate P1, i.e., an upper surface and a lower surface thereof, by adding a second coating unit 120′ having the same configuration as the coating unit 120 illustrated in FIG. 5 to the lower surface of the substrate P1.

A press unit 130 (e.g., a rolling unit) may use a rolling roller to compresses the coated substrate P2 coated with the slurry (i.e., coating mixture) by the coating unit 120 in order to produce a high-capacity and high-density secondary battery.

A winding roll 140 (e.g., a winder) may be a roll that winds and accommodates an electrode plate P3 coated and rolled by the coating unit 120 and the press unit 130.

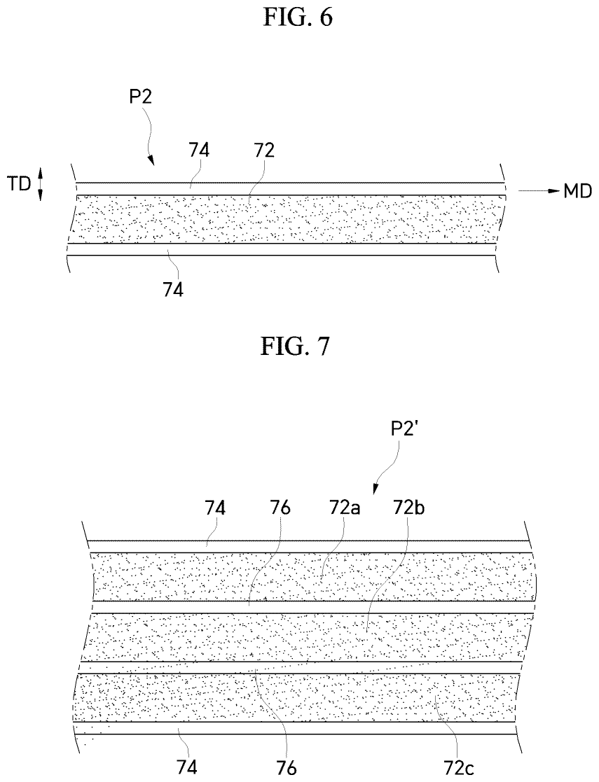

FIG. 6 illustrates the coated substrate P2 coated with an electrode material by the coating unit 120 of FIG. 5. The coated substrate P2 may have a coated portion that is coated with an active material mixture and an outer uncoated portion 74 that is left as it is without being coated. For reference, hereinafter, the width direction of the electrode plate is referred to as transverse direction TD and the longitudinal direction, which is a direction in which the electrode plate moves, is referred to as machine direction MD.

The coating unit 120 may include a device (e.g., a multi-row coating slot die) that simultaneously coats multiple rows of a coating area in the transverse direction TD of the substrate. FIG. 7 is an example of a multi-row coated substrate P2′ in which the coated portions are formed in multiple rows by the multi-row coating device, showing an example in which a first-row coated portion 72a, a second-row coated portion 72b, and a third-row coated portion 72c with inner uncoated portions 76 as boundaries therebetween are positioned side by side in the transverse direction TD. The outer uncoated portion 74 may be at the outermost part of the multi-row coated electrode plate. In this way, the multi-row coated electrode plate may be separated into individual electrode plates having the first-row coated portion 72a, the second-row coated portion 72b, or the third-row coated portion 72c by cutting the uncoated portions 76 between the first-row coated portion 72a, the second-row coated portion 72b, and the third-row coated portion 72c in the machine direction MD during a slitting process.

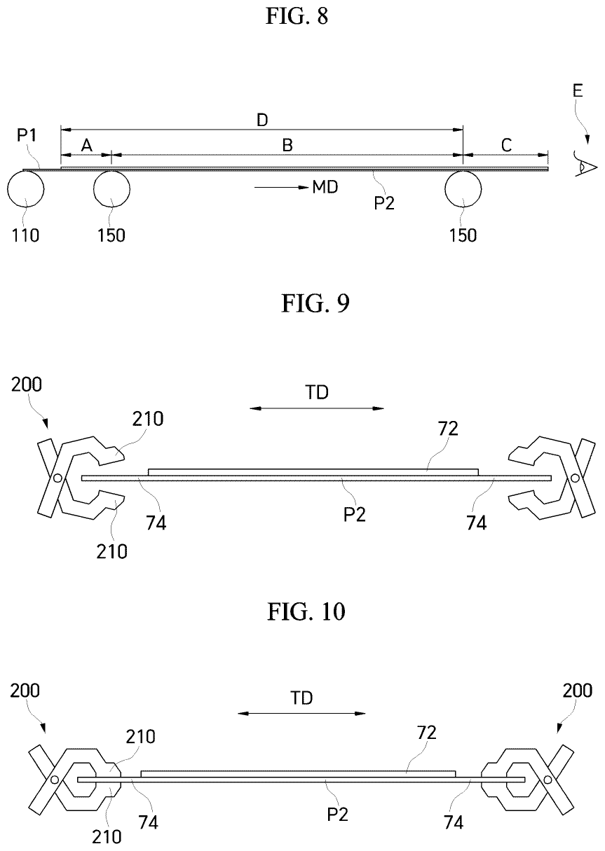

FIG. 8 is a schematic side view of the coating device according to some embodiments of the present disclosure.

Referring to FIGS. 5 and 8, the substrate P1 to be coated with the electrode plate material may be supplied to a coating line from the supply roll 110 on which the substrate P1 is wound. The substrate P1 may be coated with the electrode plate material (i.e., coating mixture) in a coating section A, dried in a drying section B into the coated substrate P2, and wound onto a reel as the electrode plate P3 in a recovery section C (e.g., onto the winding roll 140) so that the electrode plate P3 may be stored or fed into another subsequent process.

Referring to FIG. 8, in a roll-to-roll coating device, as the substrate P1 enters the coating section A to be coated and is dried in the drying section B, the substrate P1 may potentially shrink in the transfer direction TD while being transferred in the machine direction MD due to the strong tension between the rolls. That is, since tension is applied to the substrate P1 only in the machine direction MD (while being pulled), the substrate P1 may shrink in the transverse direction TD and stretch in the machine direction MD. As such, wrinkles may be formed on the resultant coated substrate P2, which may lead to occurrence of stripes on the electrode plate P3. The electrode plate stripes may cause a mismatch between a design input amount and an actual input amount of the mixture and may cause an interfacial unevenness, thereby causing the resulting electrode assembly to be different from the designed electrode assembly and a decreased charge capacity or charge/discharge cycles.

Therefore, the present disclosure prevents substrate wrinkles that may occur during the roll-to-roll coating process and drying process, thereby making it possible to manufacture a secondary battery with predictable resulting products consistent with the design and no decrease in capacity or cycles. That is, by preventing shrinkage in the transverse direction TD of the substrate in the coating section A and the drying section B to prevent wrinkles in the substrate that may occur during the roll-to-roll coating process and drying process, the occurrence of wrinkles in the substrate transferred between rolls may be suppressed or substantially minimized. To this end, the present disclosure provides an electrode plate to which slurry is uniformly applied.

In order to prevent shrinkage in the transverse direction of the substrate, the present disclosure provides a shrinkage prevention unit (e.g., a shrinkage preventer) that prevents a shrinkage force applied to the electrode plate by holding the uncoated portions 74 (FIGS. 6 and 7) of both edges of the electrode plate while the electrode plate is being transferred in an electrode plate shrinkage section D (i.e., the coating section A+the drying section B) where the widthwise shrinkage force is applied to the electrode plate.

FIGS. 9 and 10 illustrate stages in an operating principle of a shrinkage prevention unit according to some embodiments. FIGS. 9 and 10 are right side views viewed from the right side of FIG. 8 (viewed from E on the right in FIG. 8 and into the page of FIG. 5). A cross-section of the coated substrate P2 in the transverse direction TD, the coated portion 72, and both edges of the uncoated portions 74 may be seen.

For example, referring to FIGS. 9 and 10, the shrinkage prevention unit may include clamps 200 in the form of forceps for holding the substrate or releasing the substrate that has been held. In another example, the shrinkage prevention unit may include a clamp in the form of a vacuum suction device.

For example, referring to FIGS. 9 and 10, the shrinkage prevention unit (e.g., the clamps 200) may be positioned adjacent (e.g., along) the coated substrate P2 in the drying section B (e.g., between the press unit 130 and the coating unit 120 in FIG. 5). In another example, the shrinkage prevention unit (e.g., the clamps 200) may be positioned adjacent (e.g., along) the substrate Pl on which the mixture coating is performed in the coating section A (e.g., between the supply roll 110 and the coating unit 120 in FIG. 5). Therefore, in the following description, the term “substrate” will be used to refer to both the substrate P1 and the coated substrate P2.

FIG. 9 shows a stage before the clamps 200 hold both edges of the substrate, and FIG. 10 shows a stage after the clamps 200 hold both edges of the substrate. As shown in FIG. 10, both edges of the substrate may be held by the clamps 200 to prevent a widthwise shrinkage force acting on the substrate.

When the clamps 200 are used in the drying section B, the clamps 200 may be manufactured from a heat-resistant material (e.g., metal, heat-resistant polymer, or the like) that may withstand high temperatures. In addition, at least a substrate gripping portion 210 of the clamp 200 is manufactured from a material that does not damage the substrate or is surface-treated.

Since coating and drying are performed while the substrate is continuously transferred (e.g., being moved or conveyed), the clamps 200 may move (e.g., may be movable) together with the substrate. Since the clamps 200 should not damage the substrate when moving, a moving speed of the clamps 200 may be the same as a transfer speed of the substrate.

In addition, the substrate may be virtually infinitely (e.g., continuously) supplied to the coating unit 120 (e.g., the substrate wound on the supply roll 110 may be continuously supplied to the coating unit 120 until the substrate is completely unwound), and may be continuously transferred from the coating unit 120 along the machine direction MD. The clamps 200 in the shrinkage prevention unit may continuously or infinitely hold both edges of the substrate even when the clamps 200 change positions by moving together with the substrate.

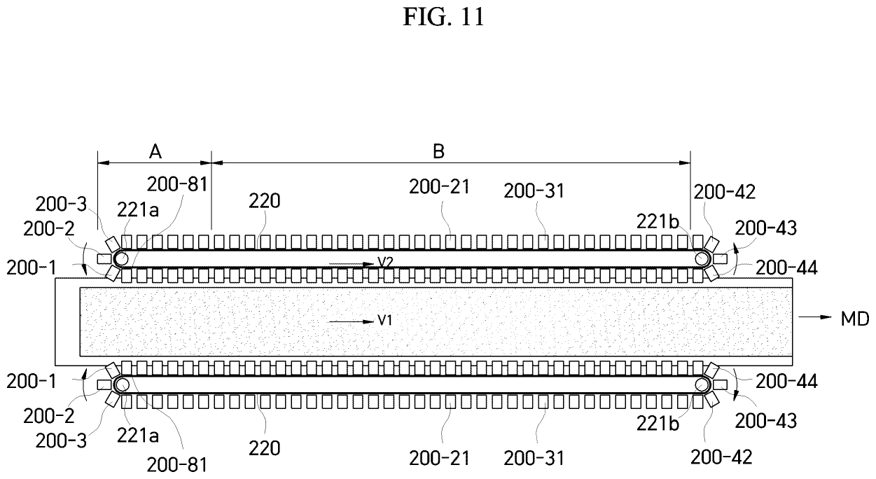

FIG. 11 is a configuration view of the shrinkage prevention unit according to some embodiments designed according to the aforementioned requirements. FIG. 11 is a plan view of the substrate passing through the coating section A and the drying section B of FIG. 8 when viewed from above.

Referring to FIG. 11, a moving mechanism may be implemented to move a plurality of the clamps 200 in a same direction as the transfer direction of the substrate. For example, the moving mechanism may be a pair of horizontal rotating belts 220. One horizontal rotating belt 220 may be installed adjacent to each of both edges (e.g., opposite edges) of the substrate. For example, referring to FIGS. 5, 8, and 11, the two horizontal rotating belts 220 may extend along and in parallel to a line extending from the coating unit 120 to the press unit 130 in FIG. 5, e.g., so each of the coating unit 120 and the drying unit 190 may be in a region between and above the two horizontal rotating belts 220.

Each rotating belt 220 may be rotated by a driver (e.g., driving wheels 221a and 221b at respective opposite ends of each of the rotating belts 220). A rotational direction of each rotating belt 220 is the same as the transfer direction MD of the substrate. A plurality of clamps 200-1 to 200-81 may be disposed on the rotating belt 220 (e.g., the plurality of clamps 200-1 to 200-81 may be arranged adjacent to each other around an entire perimeter of the rotating belt 220), so that the plurality of clamps 200-1 to 200-81 may rotate together (e.g., simultaneously) by rotation of the rotating belt 220. The rotating belt 220 only rotates at positions where the driving wheels 221a and 221b at both ends (e.g., opposite ends) are located, and most of the section of the rotating belt 220 is a section where the rotating belt moves in a straight line together with the straight movement of the substrate. For example, referring to FIG. 11, a majority of the rotating belt 220 with the majority of the clamps 200-1 to 200-81 may move in a linear direction in parallel to the machine direction MD and the substrate, while only the opposite ends of the rotating belt 220 may rotate. In the straight movement (e.g., linear movement) section, the plurality of clamps 200-1 to 200-81 may move together with the substrate in the machine direction MD in a state of preventing the shrinkage force of the substrate by holding both edges of the substrate.

The plurality of clamps 200-1 to 200-81 may grip (e.g., hold) both edges at a start point of coating of the substrate and release a state of holding both edges at an end point of drying after passing through the drying section. For example, in FIG. 11, at the coating start point, first clamps 200-1 approach both edges of the substrate and hold both edges, and then second clamps 200-2, third clamps 200-3, . . . hold both edges of the substrate and move together with the substrate. Meanwhile, at the drying end point, 44-th clamps 200-44 begin to depart from both edges of the substrate, and at this time, the clamps 200-44 release their holding of both edges and detach, returning to the previous coating start point without holding the substrate. In this way, the rotating belt 220 rotates in an endless orbital manner, and accordingly, the plurality of clamps 200-1 to 200-81 may move in the same direction as the moving direction of the substrate, thereby gripping both edges of the substrate to prevent the widthwise shrinkage force of the substrate.

That is, the clamps move at the same speed as the moving speed of the substrate and in the same direction as the moving direction of the substrate while gripping both edges of the substrate to prevent shrinkage in the transverse direction of the substrate from the coating section to the drying section (e.g., maximum 1 mm allowed), and when returning from the drying end point to the coating start point, the clamps circulate without holding both edges of the substrate. Since the clamps move in the same direction and at the same speed as the substrate, it is possible to prevent the widthwise shrinkage of the substrate without damaging the substrate.

In FIG. 11, a moving speed v1 of the substrate may equal a moving speed v2 of the clamps 200. To this end, in some embodiments, a device for synchronizing a rotational speed of the wheels 221a and 221b for driving the rotating belt 220 with the moving speed of the substrate may be included in the shrinkage prevention unit (e.g., active movement of the rotating belt 220 and the clamps). In some other embodiments, the rotating belt 220 may not actively rotate, but the rotating belt 220 may passively rotate as the clamps holding both edges of the substrate are pulled by the movement of the substrate. At this time, the wheels 221a and 221b may be idle wheels that do not output a driving force.

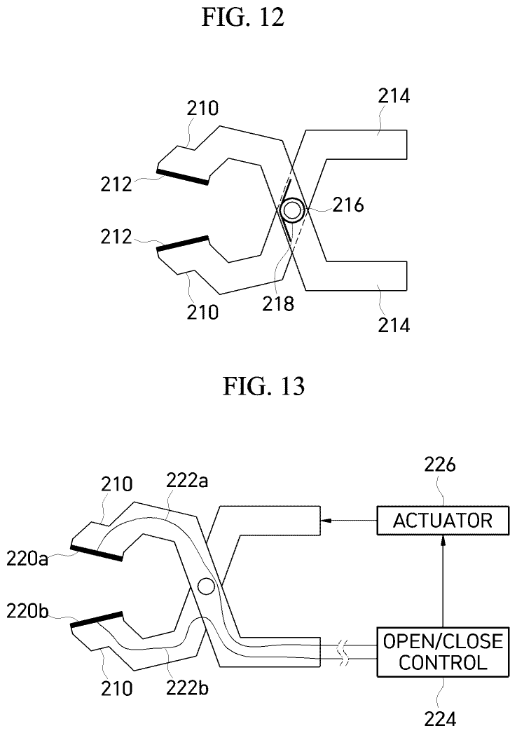

FIG. 12 shows a detailed configuration of the clamp 200. Referring to FIG. 12, the clamp 200 according to the embodiment may include the substrate gripping portion 210 that opens or closes around a rotating shaft 216, a grip operating portion 214 that opens or closes the substrate gripping portion 210, and a spring 218 that returns the substrate gripping portion 210 to an opened state after being closed.

In some embodiments, the clamp 200 may additionally include a flexible pad 212 attached to a substrate contact surface of the substrate gripping portion 210 to minimize damage to both edges of the substrate. For example, referring to FIG. 12, the flexible pads 212 may be on respective substrate gripping portions 210 and may face each other, e.g., such that the substrate may be gripped between the facing flexible pads 212.

In some embodiments, the grip operating portion 214 may be a mechanical actuator, e.g., a cylinder or the like, that operates by fluid pressure, e.g., hydraulic pressure, pneumatic pressure, or the like. In some other embodiments, the grip operating portion 214 may be an electric actuator, .g., a solenoid, a motor, or the like.

FIG. 13 is a configuration view of the clamp 200 according to some embodiments. The configuration of FIG. 13 is implemented to automatically operate the substrate gripping portion 210 when the clamp 200 approaches or departs from the substrate, as described in FIG. 11.

Referring to FIG. 13, the clamp 200 according to the embodiment may include sensors 220a and 220b installed in the substrate gripping portion 210 to detect approach to and departure from the substrate, and may output signals. The clamp 200 may further include an OPEN/CLOSE controller 224 that controls the substrate gripping portion 210 to hold both edges of the substrate or to release both edges in response to the output signals of the sensors 220a and 220b. The output signals of the sensors 220a and 220b may be transmitted to the OPEN/CLOSE controller 224 through wires 222a and 222b. A control signal output from the controller 224 may control an actuator 226 to operate the grip operating portion 214 (FIG. 12).

FIG. 14 is a configuration view of the clamp 200 according to some other embodiments. The configuration of FIG. 14 is implemented to minimize damage to the substrate by adjusting the force (grip force) with which the substrate gripping portion 210 of the clamp 200 grips the substrate.

Referring to FIG. 14, the clamp 200 according to the embodiment may include a grip force adjuster having sensors 228a and 228b installed in the substrate gripping portion 210 to detect a grip force with which the substrate gripping portion 210 grips both edges of the substrate and outputs signals, and a force controller 230 that performs control, such as changing or adjusting a grip force with which the substrate gripping portion 210 grips both edges of the substrate in response to the output signals of the sensors 228a and 228b. The output signals of the sensors 228a and 228b may be transmitted to the force controller 230 through wires 222a and 222b. A control signal output from the controller 230 may control the actuator 226 to operate the grip operating portion 214 (FIG. 12).

A method of manufacturing a secondary battery according to some embodiments of the present disclosure may include coating an electrode plate substrate of the secondary battery with an electrode material, drying the substrate coated with the electrode material, and preventing shrinkage by preventing a widthwise shrinkage force of the substrate. Here, preventing the shrinkage may include preventing the widthwise shrinkage force of the substrate by holding both edges of the substrate.

In some embodiments, preventing the shrinkage may include holding both edges by approaching the substrate and releasing both edges while departing from the substrate (e.g., to hold and release the opposite edges of the substrate in accordance with a position relative to the substrate). Here, preventing the shrinkage may include using a plurality of clamps configured to perform a function of holding both edges of the substrate and a function of releasing both edges and the plurality of clamps may be moved in the same direction as a transfer direction of the substrate.

In some embodiments, the clamp may actively move. In some other embodiments, the clamp may be passively pulled by transfer of the substrate.

In some embodiments, preventing the shrinkage may include adjusting a grip force for holding the both edges of the substrate. Here, adjusting the grip force may include detecting the grip force for holding both edges of the substrate in the preventing of the shrinkage by a sensor and changing the force for holding the both edges of the substrate corresponding to the grip force detected by the sensor.

In some embodiments, preventing the shrinkage may include detecting approach to and departure from the substrate by a sensor and holding both edges of the substrate or releasing both edges that have been held in response to a detection signal from the sensor.

Hereinafter, any material that may be usable or suitable for the secondary battery according to the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel oxide, a lithium cobalt oxide, a lithium manganese oxide, a lithium iron phosphate compound, a cobalt-free nickel-manganese oxide, or a combination thereof.

As an example, a compound represented by any one of the following formulas may be used: LiaA1−bXbO2−cDc (0.90≤a≤1.8, 0≤b≤0.5, 0≤c≤0.05); LiaMn2−bXbO4−cDc (0.90≤a≤1.8, 0≤b≤0.5, 0≤c≤0.05); LiaNi1−b−cCobXcO2−aDa (0.90≤a≤1.8, 0≤b≤0.5, 0≤c≤0.5, 0≤a≤2); LiaNi1−b−cMnbXcO2−aDa (0.90≤a≤1.8, 0≤b≤0.5, 0≤c≤0.5, 0<a<2); LiaNibCocL1dGeO2 (0.90≤a≤1.8, 0≤b≤0.9, 0≤c≤0.5, 0≤d≤0.5, 0≤e≤0.1); LiaNiGbO2 (0.90≤a≤1.8, 0.001≤b≤0.1); LiaCoGbO2 (0.90≤a≤1.8, 0.001≤b≤0.1); LiaMn1−bGbO2 (0.90≤a≤1.8, 0.001≤b≤0.1); LiaMn2GbO4 (0.90≤a≤1.8, 0.001≤b≤0.1); LiaMn1−gGgPO4 (0.90≤a≤1.8, 0≤g≤0.5); Li(3−f)Fe2(PO4)3 (0≤f≤2); and LiaFePO4 (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al).

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon negative electrode active material, which may include, e.g., crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si negative electrode active material or a Sn negative electrode active material may be used as the material capable of being doped and undoped with lithium. The Si negative electrode active material may be silicon, a silicon-carbon composite, SiOₓ (0<x<2), a Si alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate, an ester, an ether, a ketone, an alcohol solvent, an aprotic solvent, and may be used alone or in combination of two or more.

In addition, when a carbonate solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

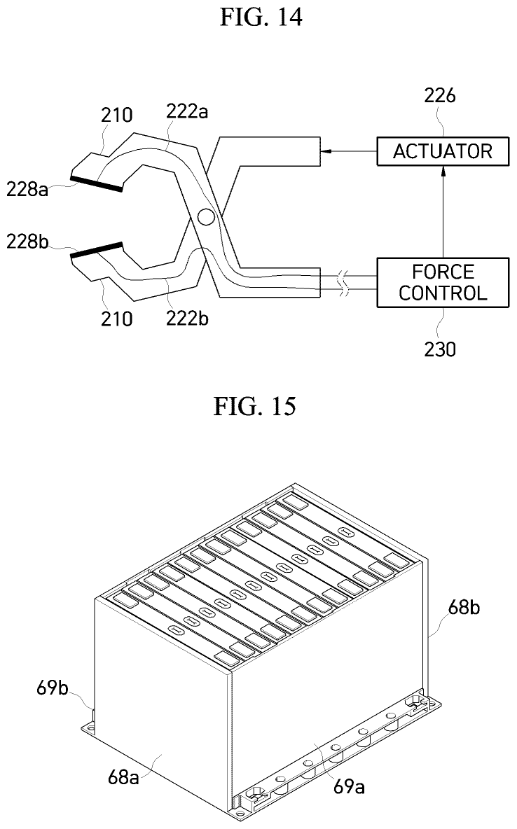

FIG. 15 is an perspective view of a secondary battery module in which secondary batteries are arranged according to embodiments of the present disclosure. With the increase in secondary battery capacity for driving electric vehicles or the like, a secondary battery module may be manufactured by arranging a plurality of secondary battery cells transversely and/or longitudinally and connecting them together. The plurality of secondary batteries may be arranged in a space defined by a pair of facing end plates 68a and 68b and a pair of facing side plates 69a and 69b. The secondary batteries may be arranged in an arrangement (direction) and number to obtain desired voltage and current specifications.

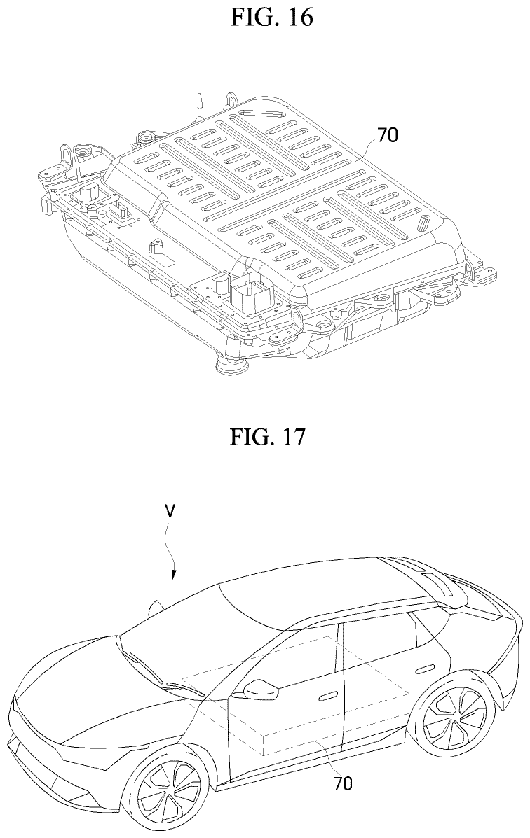

FIG. 16 is a perspective view of a battery pack 70 according to embodiments of the present disclosure. Referring to FIG. 16, the battery pack 70 may include an assembly to which individual batteries are electrically connected and a pack housing accommodating the same.

The battery pack 70 may be mounted on (or in) a vehicle. The vehicle may be, e.g., an electric vehicle, a hybrid vehicle, or a plug-in hybrid vehicle. The vehicle may be a four-wheeled vehicle or a two-wheeled vehicle.

FIG. 17 shows a vehicle V that includes the battery pack 70 shown in FIG. 16 on the lower body thereof. The vehicle V may operate by (e.g., may be powered by) receiving power from the battery pack 70.

By way of summation and review, in a roll-to-roll coating device where a substrate is transferred by rolls, the substrate may be pulled along a transfer direction (e.g., a movement direction) due to strong tension between the rolls when the substrate enters a coating section and is coated, followed by being transferred while being dried in a drying section. However, since tension is applied to the substrate in the transfer direction (e.g., along a longitudinal direction of the substrate), the substrate may stretch in the transfer direction while shrinking in the width direction. As such, wrinkles may be formed in the coated substrate, thereby causing stripes on the electrode plate. That is, since an electrode plate manufactured through a general roll-to-roll process is coated while there is tension between rolls, wrinkles parallel to a longitudinal direction are created on a substrate, and when the electrode plate is dried after being coated in this state, the electrode plate is formed according to the shape of a coated active material or the substrate, so that a wrinkled electrode plate may be potentially produced.

In contrast, the present disclosure is directed to providing an apparatus and method for manufacturing a secondary battery capable of preventing a substrate wrinkle that may occur during a roll-to-roll coating process and a drying process. That is, when coating and drying are performed in a coating device to which a clamp suggested in the present disclosure is applied, wrinkles are not created, so that an electrode plate having a uniform surface can be obtained. According to the present disclosure, by eliminating or substantially minimizing wrinkles in the roll-to-roll coating process, resultant electrode plate products that are consistent with design specifications and predictable can be obtained, and a secondary battery without a decrease in charge capacity and charge/discharge cycles can be manufactured. Eliminating or substantially minimizing wrinkles during the coating and drying stages may be advantageous because the electrode plate stripes may not be easily removed during a roll-pressing stage after coating.

Features and aspects of the present disclosure are not limited to the above, and other features and aspects not specifically mentioned herein, and aspects of the present disclosure that would address such problems, will be clearly understood by those skilled in the art from the description of the disclosure above.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An apparatus for manufacturing an electrode plate of a secondary battery, the apparatus comprising:
a transfer roller configured to transfer an electrode plate substrate of the secondary battery;
a coater configured to coat the electrode plate substrate transferred by the transfer roller with an electrode material;
a dryer configured to dry the electrode plate substrate coated by the coater; and
a shrinkage preventer configured to prevent a widthwise shrinkage force of the electrode plate substrate.

2. The apparatus as claimed in claim 1, wherein the shrinkage preventer is configured to hold opposite edges of the electrode plate substrate transferred by the transfer roller.

3. The apparatus as claimed in claim 2, wherein the shrinkage preventer is configured to hold the opposite edges and release the opposite edges, in accordance with a position relative to the electrode plate substrate.

4. The apparatus as claimed in claim 3, wherein the shrinkage preventer includes:
a plurality of clamps configured to hold and release the opposite edges of the electrode plate substrate; and
a moving mechanism configured to move the plurality of clamps in a same direction as a transfer direction of the substrate.

5. The apparatus as claimed in claim 4, wherein each of the plurality of clamps includes a flexible pad positioned on a surface that contacts the electrode plate substrate.

6. The apparatus as claimed in claim 4, wherein the moving mechanism is a rotating belt that includes driving wheels to move the plurality of clamps.

7. The apparatus as claimed in claim 4, wherein the moving mechanism is a horizontal rotating belt configured to be pulled by the electrode plate substrate that is being transferred.

8. The apparatus as claimed in claim 4, wherein the shrinkage preventer includes a grip force adjuster configured to adjust a grip force of corresponding ones of the plurality of clamps.

9. The apparatus as claimed in claim 8, wherein the grip force adjuster includes:
a sensor configured to detect the grip force of the corresponding ones of the plurality of clamps; and
a force controller configured to adjust the grip force detected by the sensor.

10. The apparatus as claimed in claim 3, wherein the shrinkage preventer includes:
a sensor configured to detect an approach to and a departure from the electrode plate substrate and to output a signal; and
a controller configured to control the shrinkage preventer to hold the opposite edges and release the opposite edges, in accordance with the signal from the sensor.

11. A method of manufacturing an electrode plate of a secondary battery, the method comprising:
coating an electrode plate substrate of the secondary battery with an electrode material;
drying the electrode plate substrate coated with the electrode material; and
preventing a widthwise shrinkage force of the electrode plate substrate.

12. The method as claimed in claim 11, wherein preventing the widthwise shrinkage force of the electrode plate substrate includes holding opposite edges of the electrode plate substrate.

13. The method as claimed in claim 12, wherein holding the opposite edges of the electrode plate substrate includes holding the opposite edges when approaching the electrode plate substrate and releasing the opposite edges when departing from the electrode plate substrate.

14. The method as claimed in claim 13, wherein holding the opposite edges of the electrode plate substrate includes using a plurality of clamps to hold and release the opposite edges of the electrode plate substrate, the plurality of clamps being movable in a same direction as a transfer direction of the electrode plate substrate.

15. The method as claimed in claim 14, wherein using the plurality of clamps includes active movement of the clamps.

16. The method as claimed in claim 14, wherein using the plurality of clamps includes passively pulling the plurality of clamps by a transfer of the electrode plate substrate.

17. The method as claimed in claim 13, wherein preventing the widthwise shrinkage force of the electrode plate substrate:
detecting approach to and departure from the electrode plate substrate by a sensor; and
holding the opposite edges of the electrode plate substrate or releasing the opposite edges in response to a detection signal from the sensor.

18. The method as claimed in claim 12, wherein preventing the widthwise shrinkage force of the electrode plate substrate further includes adjusting a grip force while holding the opposite edges of the electrode plate substrate.

19. The method as claimed in claim 18, wherein adjusting the grip force includes:
detecting the grip force holding the opposite edges of the electrode plate substrate by a sensor; and
adjusting the grip force for holding the opposite edges of the electrode plate substrate in accordance with the sensor.
